(19) United States
(12) Patent Application Publication
(10) Pub. No.: US 2012/0050711 A1
(43) Pub. Date: Mar. 1, 2012

(54) CHUCK ASSEMBLY BACK SIDE RETICLE CLEANER

(75) Inventor: Gary Hillman, Livingston, NJ (US)

(73) Assignee: Gary Hillman, Livingston, NJ (US)

(21) Appl. No.: 13/221,387

(22) Filed: Aug. 30, 2011

Related U.S. Application Data
(60) Provisional application No. 61/379,230, filed on Sep. 1, 2010.

(51) Int. Cl. G03B 27/62

(52) U.S. Cl. 355/75

(57) ABSTRACT

An improved technique for fixedly holding a reticle in a reticle chuck of the reticle simplifies the process of cleaning the back surface of the reticle by exposing the entire back surface. The technique includes approaching the reticle chuck with the reticle held at an initial orientation, aligning the reticle chuck with the initial orientation of the reticle and positioning the front surface of the reticle slightly below the top of a receiving area in the reticle chuck. The technique also includes placing a downward force on a set of spring-loaded pins, each spring-loaded pin configured to move within a corresponding hole in the chuck, the downward force providing a clearance for the reticle to enter a receiving cavity. The technique further includes aligning a centerline of the reticle in the receiving cavity with a centerline of the reticle chuck, simultaneously, and in unison, moving the reticle and the reticle chuck in a downward direction and supporting the reticle with the spring-loaded pins within the chuck.

### BACKGROUND

Reticles, also known as photomasks, are used in semiconductor manufacturing to provide a representation of a circuit layer to be imaged in photoresist on a wafer. Reticles designed for use in a modern lithography stepper or scanner typically have features that are magnified with respect to their wafer images by factors of at least 4×.

Even with the magnification of reticle features, the requirement of printing nanometer-scale critical dimensions results in correspondingly small features on the front side of the reticle. The mask error factor (MEF), which quantifies how much a small error in a feature on the reticle gets magnified beyond the designed magnification due to process effects. Process designers minimize the MEF in order to allow as generous an error budget to the reticle manufacturer as possible.

In order to allow for such an error budget, one must consider the degrading effect of particles on the reticle surface on the error budget. The first line of protection against the effect of such particles is a pellicle. A pellicle is a thin, transparent polymer film which is mounted to the front surface of the reticle, i.e., the surface having the features to be printed [while, further, the back surface of the reticle is the surface upon which typically no features are present]. Conventional reticle cleaners designed to clean reticle surfaces of such particles are typically in place to remove such particles either in-situ or off-line.

### SUMMARY

Unfortunately, the conventional reticle cleaners suffer from deficiencies. For example, a conventional reticle cleaner requires removal, and consequently remounting, of the pellicle during cleaning. Remounting the pellicle after cleaning leaves a potential for registration errors which originate from a small imbalance of forces in the mounting process. Further, unmounting and remounting a pellicle reduces the life of a reticle as well as removes a reticle from the available inventory for production.

In contrast to the conventional reticle cleaner which requires removal of the pellicle and with the removal, a risk of mask registration errors, an improved technique involves supporting a reticle within a reticle chuck by a set of spring-loaded pins which are in turn supported and configured to move within holes in the reticle chuck. The spring-loaded pins allow for the entire reticle, including a pellicle attached to the front surface of the reticle, to fit within an enclosure in the reticle chuck. When the reticle is loaded in the chuck and supported by the spring-loaded pins, the backside of the reticle is exposed and able to be cleaned without removal of the pellicle.

One embodiment of the improved technique is method of placing and fixedly holding a reticle in a reticle chuck. The method includes approaching the reticle chuck with the reticle held at an initial orientation, aligning the reticle chuck with the initial orientation of the reticle and positioning the front surface of the reticle slightly below the top of a receiving cavity in the reticle chuck. The method also includes placing a downward force on a set of spring-loaded pins, each spring-loaded pin configured to move within a corresponding hole in the chuck, the downward force providing a clearance for the reticle to enter a receiving cavity. The method further includes aligning a centerline of the reticle in the receiving cavity with a centerline of the reticle chuck, simultaneously, and in unison, moving the reticle and the reticle chuck in a downward direction and supporting the reticle with the spring-loaded pins within the chuck.

A further embodiment of the improved technique is a system constructed and arranged to position and fixedly hold a reticle having a front surface which includes a set of features to be imaged onto a wafer, the reticle having a pellicle mounted on the front surface. The system includes a set of spring-loaded pins, each spring-loaded pin in the set of spring-loaded pins having a head. The system also includes a reticle chuck, where the reticle chuck includes a base having a top surface and a bottom surface, the bottom surface having a receiving cavity having a first gap and a second gap, the first gap configured to fit the reticle, the second gap configured to fit the pellicle and a set of holes. The reticle, upon transfer to the reticle chuck, is fixedly held between the heads of the spring-loaded pins and the receiving cavity of the reticle chuck base.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1(a) is a schematic diagram of a reticle chuck configured in accordance with the improved technique.

FIG. 1(b) is a schematic diagram of a close-up view of the area surrounding a spring-loaded pin as illustrated in FIG. 1(a).

FIG. 2 is a schematic diagram of the reticle chuck assembly illustrated in FIG. 1(a) including a servo motor.

FIG. 3 is a schematic diagram of the reticle chuck assembly illustrated in FIG. 1(a) including a robot reticle handler.

FIG. 4 is a schematic diagram of the backside reticle cleaning assembly which is constructed and arranged to clean the backside of a reticle fixedly held in the reticle chuck illustrated in FIG. 1(a).

FIG. 5 is a flow chart illustrating a method of fixedly holding a reticle in the reticle chuck illustrated in FIG. 1(a).

### DETAILED DESCRIPTION

An improved technique for securing a reticle in a reticle chuck for cleaning the back surface of the reticle allows for exposure of the exposed back surface of the reticle for a faster and more effective clean.

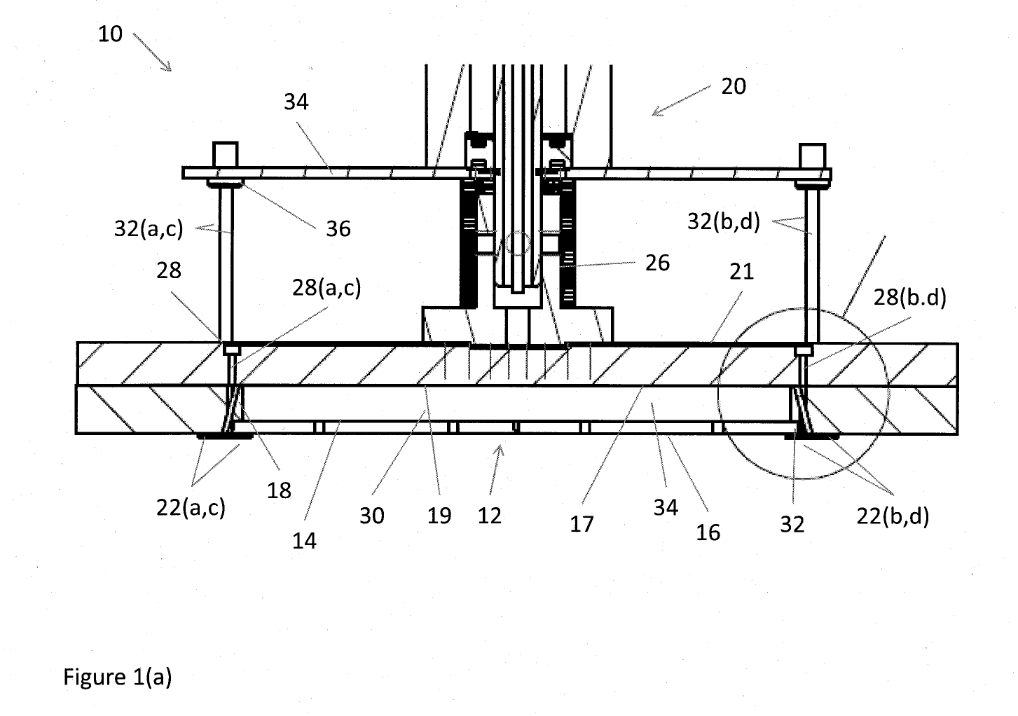

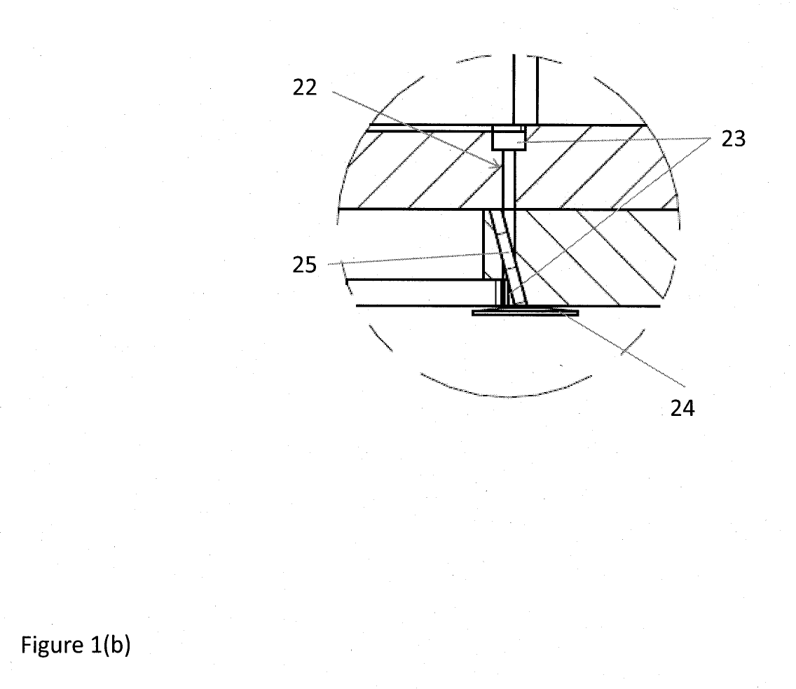

FIG. 1(a) shows a system 10 configured to fixedly hold a reticle in such a manner. System 10 includes a reticle chuck 20 and a set of spring-loaded pins 22(a-d) [spring-loaded pins 22]. System 10 can also include a robot 40 configured to automatically bring a reticle 12 to reticle chuck 20 at a particular orientation. Further detail of the spring-loaded pins 22 are shown with regard to FIG. 1(b).

FIG. 1(b) further illustrates a spring-loaded pin 22. Spring-loaded pin 22 has a head 24 which moves relative to the body 25 of the pin 22 along the axis of symmetry of the pin 22. The springs 25 within the spring-loaded pin 22 carry enough tension so that the set of spring-loaded pins 22 together can hold the reticle 12 in the reticle chuck. Spring-loaded pin 22 are, in one arrangement, accompanied by a pair of sapphire jewel bearings 23 with one sapphire jewel bearing 23 at each end of spring-loaded pin 22.

Referring back to FIG. 1(a), reticle chuck 20 includes support portion 28, a rotating head 26, front surface 21, back surface 17, and receiving portion 30. Reticle chuck 20 is preferably made from stainless steel, which, in combination with sapphire jewel bearings 23, generates no particulates as spring-loaded pin 22 is moved relative to reticle chuck 20.

Support portion 28 includes the corners of the reticle chuck 20. In each corner is a hole 28(a-d) extending completely through the reticle chuck 20. (If the reticle chuck 20 is circular in shape, then the support portion 28 is defined so as to form corners of a rectangle.) Holes 28 (a-d) have a diameter sufficient to allow smooth yet constrained motion of spring-loaded pins 22.

In some arrangements, system 10 includes a set of four legs 32(a-d) surrounding the reticle chuck 20 and a plate 34 fixedly attached to the set of four legs 32 and positioned above the reticle chuck 20. Spring-loaded pins 22, in this arrangement, are constrained by the plate 34 rather than by bearings 23. An advantage of constraining the spring-loaded pins 22 in this manner is that the spring-loaded pins 22 will not contact the reticle chuck 20. When there is such contact, there is some particle abrasion and the resulting loose particles can pose a risk to the reticle 12. Because the pins 22 are constrained by the plate 34 above reticle chuck 20, they preferably contain materials with a high value of the Young's modulus (i.e., have a high stiffness). In this arrangement, as the reticle 12 moves down on the pins 22, the plate 34 also moves in the same direction along ball-bearing slides 36. The advantage of such ball-bearing slides 36 is that the movement of plate 34 generates far fewer particles due to abrasion than by guiding the pins along the jewel bearings 23.

Reticle 12 is typically a standard 6″×6″×0.25″ quartz plate with a front surface 14 and a back surface 16, although other sizes are possible. Attached to the front surface 14 is a pellicle assembly 18, which is mounted prior to use in a manufacturing environment. Pellicle assembly 18 contains a pellicle 19 and is not dismounted during cleaning.

Receiving portion 30 of reticle chuck 20 is constructed and arranged to snugly fit reticle 12 will fit with its pellicle assembly 18 within the back surface 23 of reticle chuck 20. Receiving portion 30 is preferably constructed and arranged to form a cavity which snugly fits the reticle with the pellicle assembly 18 mounted. Alternatively, receiving portion 30 is constructed and arranged to form a cavity which includes two gaps within the back surface 23 of reticle chuck 20. The first gap 32 is configured to snugly fit the reticle 14, while the second gap 34 is configured to snugly fit the pellicle assembly 18.

In some arrangements, the space between reticle 12 and receiving portion 30 of reticle chuck 20 is filled with a gas which contains mainly, e.g., nitrogen, air, etc. The gas protects reticle 12 by keeping moisture out of the space 36 and maintains a low relative humidity to ensure the space is clean.

In some arrangements, a cleaning assembly requires precise control of the motion of the reticle 12 as reticle 12 is being cleaned. In that regard, a servo motor would well serve this requirement.

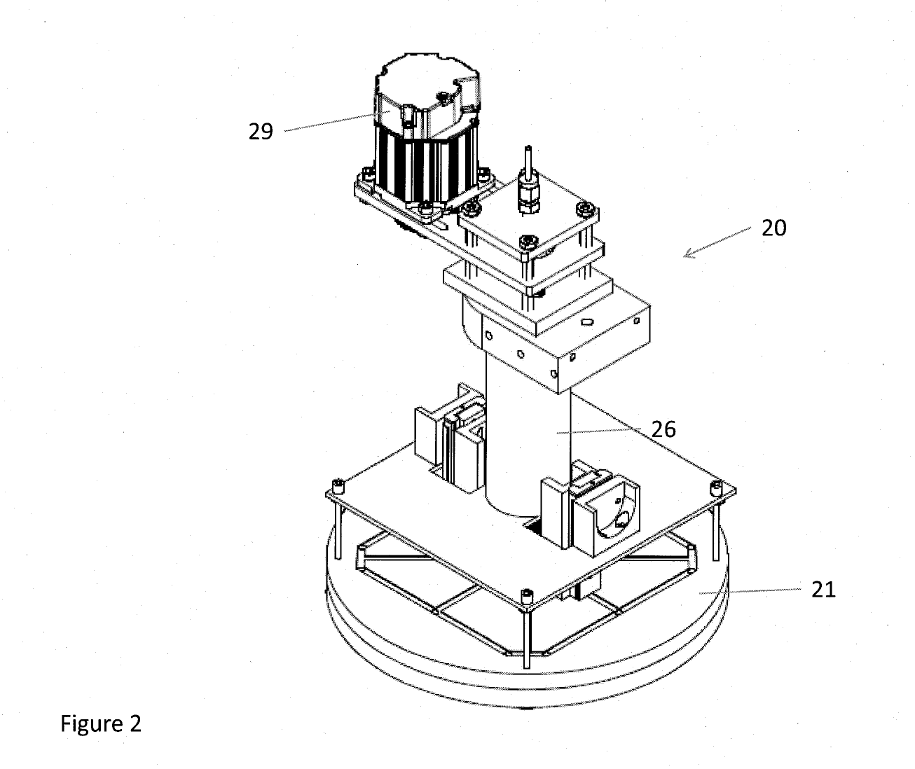

FIG. 2 illustrates a servo motor 29 which is constructed and arranged to rotate rotating head 26. Rotating head 26 is connected to the front surface 21 of reticle chuck 20. Rotating head 26 is configured to rotate reticle chuck 20 about the axis of symmetry rotating head 26. Servo motor 29 is typically finely adjusted so as to move rotating head 26 at a very small resolution in angle, e.g., to within 1/20,000 of a revolution.

In some arrangements, the reticle cleaning process is performed in an atmosphere of automation. In that regard, a robot would handle the loading and unloading of reticle 12 to and from reticle chuck 20.

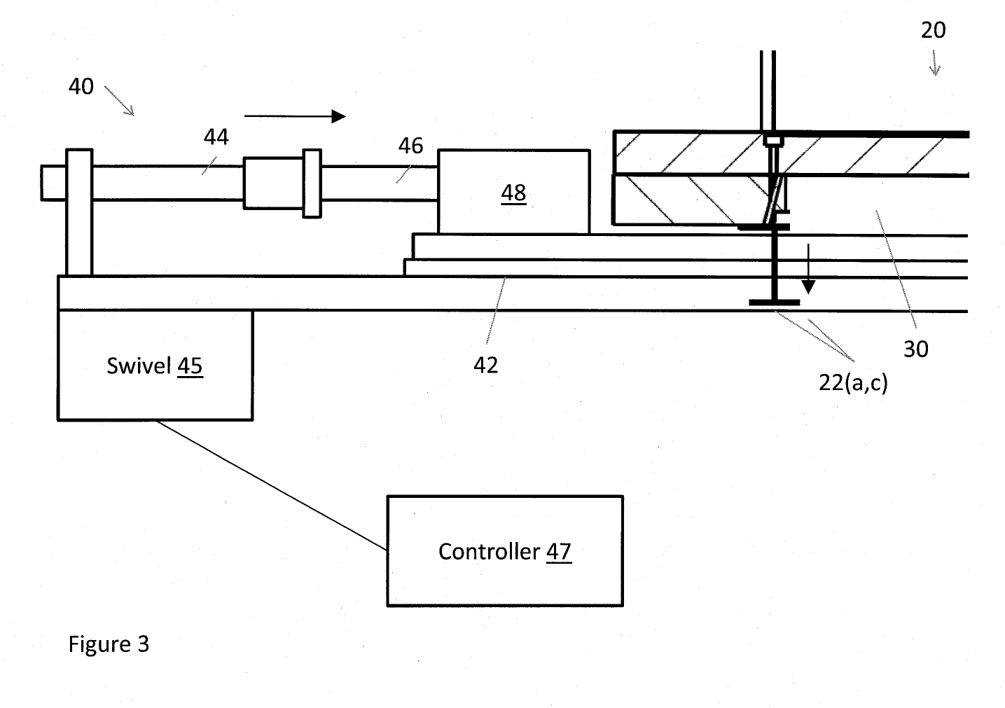

FIG. 3 illustrates a robot 40 which is constructed and arranged to move reticle 12 in and out of reticle chuck 20. Robot 40 includes a clamp 42, a first arm 44, a joint 46, a second arm 48, and swivel 45. Clamp 42 is configured to grab and release reticle 12 without damage to any features on the front surface of reticle 21 or pellicle assembly 18. Swivel 45 is controlled by a servo motor and controls the orientation of robot 40. First arm 44 is connected to clamp 42 and controls orientation of reticle 12 within clamp 42. Second arm 48 is connected to swivel 45. Joint 46 connects first arm 44 to second arm 48 and provides an independent degree of freedom in the robot motion.

During operation, robot 40 approaches reticle chuck 20 with reticle 12 held within clamp 42 at an initial orientation. Motion of robot 40 is controlled via a computer controller 47. Controller 47 moves the clamp 42 toward reticle 12, which initially resides in a holder, and grabs reticle 12. Reticle 12 is then removed from the holder and the swivel 45 moves the robot 40 in the direction of the reticle chuck 20. First arm 44, second arm 48, and joint 46 define the robot motion in such a way that the reticle 12 is introduced to the reticle chuck 20 at the initial orientation.

After this introduction, servo motor 29 incrementally rotates reticle chuck rotating head 26 in such a way as to align reticle chuck 20 with the initial orientation. Robot 40 then positions the front surface of reticle 12 slightly below the top of receiving portion 30. Reticle 12 is now ready to be placed into reticle chuck 20.

A downward force is applied to the heads 24 of spring-loaded pins 22, the pins 22 located within holes 28. The downward force in the heads 24 allows for enough clearance within receiving cavity 30 for the robot to move reticle 12 into reticle chuck 20. Once reticle 12 is in position within receiving portion 30, centerlines of reticle 12 and reticle chuck 20 are aligned.

After alignment of the centerlines, the reticle 12 and reticle chuck 20 are moved simultaneously and in unison so that the vertical constraint of reticle 12 (which prevents reticle 12 from falling) is transferred from robot 40 to reticle chuck 20. As the robot 40 descends, the spring-loaded pins 22 descend similarly so that reticle 12 is now constrained in all directions by the combination of reticle chuck 20 and spring-loaded pins 22.

Once reticle 12 is so constrained, the controller moves robot 40 from reticle chuck 20. A second controller 49 then engages reticle cleaning assembly 50 to begin the cleaning of the back surface 16 of reticle 12.

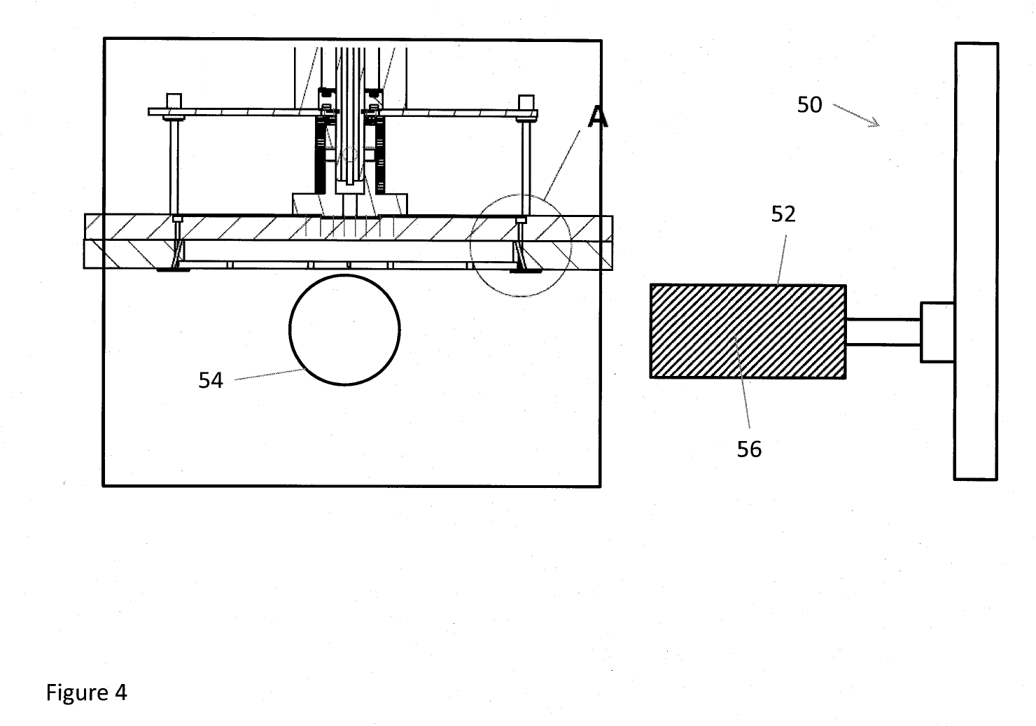

FIG. 4 illustrates a reticle cleaning assembly 50 which includes a cylindrical brush 52 and a PVA sponge 54.

Cylindrical brush 52 is constructed and arranged to remove large particles from the surface of reticle 12. Cylindrical brush 52 includes nylon bristles 56, each of which is about 125 μm in diameter. The nylon bristles have the property of providing a skidding motion on the bottom quartz surface of reticle 12. Through this skidding motion, cylindrical brush 52 is able to free large particles stuck to the quartz surface of reticle 12. In freeing the particles, cylindrical brush 52 has the effect of controlling the placement of moisture on the reticle 12, lowering the pH on the quartz surface of reticle 12 and thereby preventing a re-sticking of any large particles to the reticle 12.

The length of cylindrical brush 52 along its axis is set so that cylindrical brush 52 does not extend beyond an edge of reticle 12. That is, the length is set so that cylindrical brush 52 does not break over an edge of reticle 12. Such a length eliminates the risk of cylindrical brush 52 inadvertently “flicking”, which can result in a violent motion of the bristle 56 which interferes with control of water placement over the quartz surface of reticle 12.

PVA sponge 54 is constructed and arranged to remove particles on reticle 12 which are too small to be removed by cylindrical brush 52. PVA sponge rotates about an axis and comes into contact with the bottom surface of reticle 12. As opposed to cylindrical brush 52, PVA sponge 54 can extend beyond an edge of reticle 12.

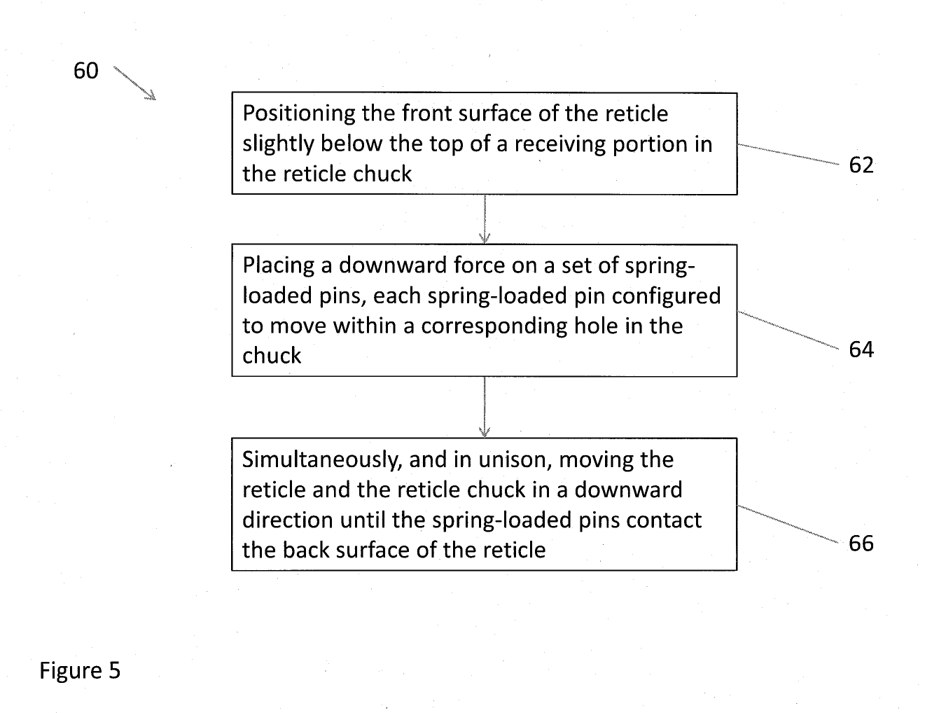

FIG. 5 illustrates a method 60 of placing and fixedly holding a reticle in a reticle chuck. In step 62, a front surface of the reticle is positioned slightly below the top of a receiving portion in the reticle chuck. In step 64, a downward force is placed on a set of spring-loaded pins, each spring-loaded pin configured to move within a corresponding hole in the reticle chuck. In step 66, the reticle and reticle chuck are moved simultaneously and in unison in a downward direction until the spring-loaded pins contact the back surface of the reticle.

While various embodiments of the invention have been particularly shown and described, it will be understood by those skilled in the art that various changes in form and details may be made therein without departing from the spirit and scope of the invention as defined by the appended claims.

What is claimed is:

1. A method of placing and fixedly holding a reticle in a reticle chuck, the reticle having a back surface to be cleaned and a front surface opposite the back surface, the method comprising:
positioning the front surface of the reticle slightly below the top of a receiving portion in the reticle chuck;
placing a downward force on a set of spring-loaded pins, each spring-loaded pin configured to move within a corresponding hole in the reticle chuck; and
simultaneously, and in unison, moving the reticle and the reticle chuck in a downward direction until the spring-loaded pins contact the back surface of the reticle.

2. A method as in claim 1, wherein a pellicle is mounted to the front surface of the reticle;
wherein placing the front surface of the reticle slightly below the top of a receiving portion includes:
providing a clearance for the reticle to enter the receiving portion;
wherein the receiving portion forms a cavity constructed and arranged to fit the reticle with pellicle mounted.

3. A method as in claim 2, wherein the method further comprises:
prior to positioning the front surface of the reticle, aligning a centerline of the reticle in the receiving cavity with a centerline of the reticle chuck;
wherein positioning the front surface of the reticle slightly below the top of the receiving portion includes:
aligning the reticle with the receiving portion.

4. A method as in claim 3, wherein the method further comprises:
prior to aligning a centerline of the reticle in the receiving cavity, maneuvering a robot toward the reticle chuck with the reticle held at an initial orientation; and
aligning the reticle chuck with the initial orientation of the reticle.

5. A method as in claim 4, wherein aligning the reticle chuck includes rotating, with a servo motor, the reticle chuck about the longitudinal axis of the reticle chuck.

6. A method as in claim 2, further comprising:
cleaning, with a cylindrical brush and a PVA sponge, the back surface of the reticle, the cylindrical brush not extending beyond the back surface of the reticle, the PVA sponge extending beyond the back surface of the reticle.

7. A method as in claim 1, wherein the reticle chuck includes a set of four legs and a plate fixedly attached to the set of four legs;
wherein placing a downward force on a set of spring-loaded pins includes:
constraining, by the plate, the motion of the spring-loaded pins;

8. A system configured to position and fixedly hold a reticle having a back surface to be cleaned and a front surface opposite the back surface, the system comprising:
a reticle chuck including:
a base having a top surface and a bottom surface, the bottom surface having a receiving portion; and
a mounting portion coupled to the base portion, the mounting portion defining a set of holes in the base portion; and
a set of spring-loaded pins, each spring-loaded pin of the set of spring-loaded pins having a head, the set of spring loaded pins constructed and arranged to contact the back surface of the reticle and fixedly hold the reticle between the heads of the spring-loaded pins and the receiving portion of the reticle chuck base portion.

9. A system as in claim 8, wherein a pellicle is mounted to the front surface of the reticle;
wherein the receiving portion forms a cavity constructed and arranged to fit the reticle with the pellicle mounted.

10. A system as in claim 9, further comprising:
a robot assembly constructed and arranged to transfer the reticle to the reticle chuck.

11. A system as in claim 10, further comprising:
a servo motor constructed and arranged to rotate the reticle chuck about the longitudinal axis of the reticle chuck.

12. A system as in claim 9, further comprising:
a reticle cleaning apparatus configured to clean the back surface of the reticle as the reticle is fixedly held in place between the heads of the spring-loaded pins and the receiving cavity of the reticle chuck base.

13. A system as in claim 12, wherein the reticle cleaning apparatus includes:
a cylindrical brush; and
a PVA sponge;
wherein the cylindrical brush does not extend beyond the back surface of the reticle, and the PVA sponge extends beyond the back surface of the reticle.

14. A system as in claim 9, wherein the receiving portion forms a cavity having a first section and a second section, the first section being constructed and arranged to fit the reticle, the second section being constructed and arranged to fit the pellicle.

15. A system as in claim 8, further comprising:
a set of four legs; and
a plate fixedly attached to the set of four legs;
wherein the set of spring-loaded pins are constrained in motion by the plate.

16. A system configured to clean a back surface of a reticle, comprising:
a cylindrical brush; and
a PVA sponge;
wherein the cylindrical brush does not extend beyond the back surface of the reticle, and the PVA sponge extends beyond the back surface of the reticle.
